(19) United States
(12) Patent Application Publication
(10) Pub. No.: US 2021/0042947 A1
(43) Pub. Date: Feb. 11, 2021

(54) METHOD AND APPARATUS FOR PROCESSING DATA, ELECTRONIC DEVICE AND STORAGE MEDIUM

(71) Applicant: BEIJING SENSETIME TECHNOLOGY DEVELOPMENT CO., LTD., Beijing (CN)

(72) Inventors: Fubao XIE, Beijing (CN); Zhuang ZOU, Beijing (CN); Wentao LIU, Beijing (CN); Chen QIAN, Beijing (CN)

(21) Appl. No.: 17/078,750

(22) Filed: Oct. 23, 2020

Related U.S. Application Data
(63) Continuation of application No. PCT/CN2019/083963, filed on Apr. 23, 2019.

(30) Foreign Application Priority Data
Sep. 18, 2018 (CN) 201811090338.5

(51) Int. Cl. G06T 7/50; G06T 11/00; G06T 7/00

(52) U.S. Cl. CPC G06T 7/50; G06T 7/97; G06T 11/00

(57) ABSTRACT

Provided in the embodiments of the disclosure are a method and an apparatus for processing data, an electronic device and a storage medium. The method for processing data includes: obtaining a framework of a target according to a two-dimensional (2D) image; determining an x^{th} distance from an x^{th} pixel in the 2D image to the framework; and determining, according to the x^{th} distance, whether the x^{th} pixel is a pixel forming the target.

### CROSS-REFERENCE TO RELATED APPLICATIONS

This application is a continuation of International Application No. PCT/CN2019/083963, filed on Apr. 23, 2019, which is based upon and claims priority to Chinese patent application No. 201811090338.5, filed on Sep. 18, 2018. The contents of International Application No. PCT/CN2019/083963 and Chinese patent application No. 201811090338.5 are hereby incorporated by reference in their entireties.

### TECHNICAL FIELD

The disclosure relates, but is not limited, to the field of information technologies, and in particular to a method and an apparatus for processing data, an electronic device and a storage medium.

### BACKGROUND

When an image is formed by photographing with a camera, a target may need to be extracted from the photographed image. There are a variety of manners for extracting the target from the image in the related art. Manner 1: the target is extracted based on features of the target. Manner 2: the target is extracted based on a deep learning model. When the target is extracted based on the deep learning model, there may be problems such as being very difficult and taking a long time to train the deep learning model. Moreover, the accuracy in extracting targets in different states by the deep learning model varies greatly.

### SUMMARY

In view of this, embodiments of the disclosure are intended to provide a method and an apparatus for processing data, an electronic device and a storage medium.

A method for processing data may include: obtaining a framework of a target according to a two-dimensional (2D) image; determining an x^{th} distance from an x^{th} pixel in the 2D image to the framework; and determining, according to the x^{th} distance, whether the x^{th} pixel is a pixel forming the target

An apparatus for processing data may include: a first obtaining module, configured to obtain a framework of a target according to a two-dimensional (2D) image; a first determination module, configured to determine an x^{th} distance from an x^{th} pixel in the 2D image to the framework; and a second determination module, configured to determine, according to the x^{th} distance, whether the x^{th} pixel is a pixel forming the target.

A non-transitory computer-readable storage medium having stored thereon computer programs that, when being executed by a computer, cause the computer to carry out the following: obtaining a framework of a target according to a two-dimensional (2D) image; determining an x^{th} distance from an x^{th} pixel in the 2D image to the framework; and determining, according to the x^{th} distance, whether the x^{th} pixel is a pixel forming the target.

An apparatus for processing data, including; a processor; and a memory configured to store instructions which, when being executed by the processor, cause the processor to carry out the following: obtaining a framework of a target according to a two-dimensional (2D) image; determining an x^{th} distance from an x^{th} pixel in the 2D image to the framework; and determining, according to the x^{th} distance, whether the x^{th} pixel is a pixel forming the target.

### BRIEF DESCRIPTION OF THE DRAWINGS

FIG. 1 illustrates a schematic flowchart of a method for processing data according to an embodiment of the disclosure.

FIG. 2 illustrates a schematic diagram of a framework of a target according to an embodiment of the disclosure.

FIG. 3 illustrates a schematic diagram of another framework of the target according to an embodiment of the disclosure.

FIG. 4 illustrates a schematic diagram of determining a distance from a pixel to a corresponding framework body according to an embodiment of the disclosure.

FIG. 5 illustrates a schematic flowchart of another method for processing data according to an embodiment of the disclosure.

FIG. 6 illustrates a schematic flowchart of still another method for processing data according to an embodiment of the disclosure.

FIG. 7 illustrates a schematic structural diagram of an apparatus for processing data according to an embodiment of the disclosure.

FIG. 8 illustrates a schematic structural diagram of an electronic device according to an embodiment of the disclosure.

### DETAILED DESCRIPTION

The technical solutions of the disclosure are further described below in detail in combination with the accompanying drawings and particular embodiments.

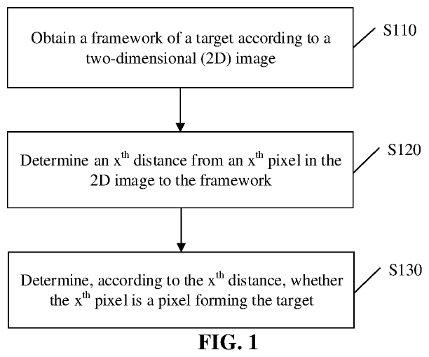

As illustrated in FIG. 1, provided in the embodiment is a method for processing data. The method for processing data includes the following operations.

In S110: a framework of a target is obtained according to a two-dimensional (2D) image.

In S120: an x^{th} distance from an x^{th} pixel in the 2D image to the framework is determined.

In S130: whether the x^{th} pixel is a pixel forming the target is determined according to the x^{th} distance.

The method for processing data provided in the embodiment may be applied to one or more electronic devices. The electronic device may include a processor. The processor may implement, through execution of executable instructions such as a computer program, one or more operations in the method for processing data. In some embodiments, a single electronic device may be used to perform integrated data processing, or multiple electronic devices may be used to perform distributed data processing.

In the embodiment, the 2D image may be a component of a three-dimensional (3D) image. The 3D image further includes a depth image corresponding to the 2D image. The 2D image and the depth image may be acquired for a same target.

The 2D image may be a Red Green Blue (RGB) image, a YUV image, or the like. The depth image may contain depth information acquired by use of a depth acquisition module. A pixel value of the depth image is a depth value. The depth value may be a distance from the image acquisition module to the target. Herein, in the embodiment of the disclosure, the actual depth value originates from the depth image.

If the target is a human person or an animal, the framework of the target may be a skeleton of the human person or the animal. Key points on the skeleton of the human person or the animal represent the whole framework of the target, and thus a 3D feature of the framework of the target may be a 3D feature of a key point on the framework of the target. The 3D feature includes: coordinate values in x and y directions within a coordinate system of a camera, and further includes a depth value from the target to the camera.

In the embodiment, 3D coordinates output based on the 3D image are processed to obtain a 3D posture. In the embodiment, the 3D posture may be represented by relative positions between 3D coordinates in a 3D space coordinate system.

Operation S110 may include: the framework of the target is extracted by using a deep learning module such as a neutral network with the 2D image as an input. With the target being an animal as an example, the framework may be the skeleton of the animal, and with the target being a human person as an example, the framework may be the skeleton of the human person. In another example, the target is a mobile tool, the framework may be a framework body of the mobile tool.

Operation S110 that the framework of the target is obtained according to the 2D image may include that: key points of the target are extracted by using the deep learning module such as the neutral network, and these key points are connected to obtain the framework.

Description is made with the target being a human person as an example. For example, in operation S110, pixels corresponding to joints of the human person may be extracted, so as to determine the key points, and then, these key points are connected to form the framework. In some embodiments, the key points may be: pixels where a head, a neck, an elbow, a wrist, a hip, a knee and an ankle are located.

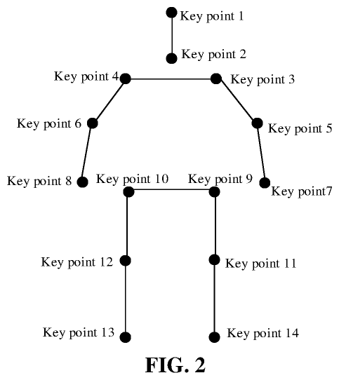

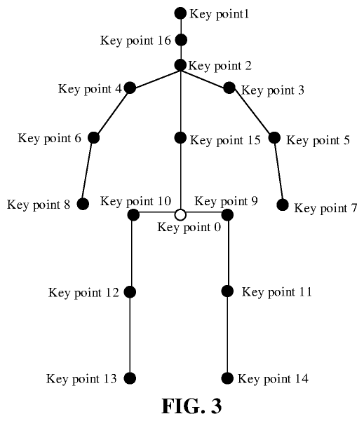

FIG. 2 illustrates a schematic diagram of a framework of a target, with the target being a human person. In FIG. 2, 14 key points are displayed, which are respectively numbered as key point 1 to key point 14. FIG. 3 illustrates a schematic diagram of a framework of a target, with the target being a human person. In FIG. 3, 17 key points are displayed, which are respectively numbered as key point 0 to key point 16. The serial numbers of the key points in FIG. 2 and FIG. 3 are merely given as examples, and the disclosure is not limited to the above particular serial numbers.

In FIG. 3, key point 0 may serve as a root node. The 2D coordinates of key point 0 in the coordinate system of the camera may be (0, 0), and the 3D coordinates of key point 0 in the coordinate system of the camera may be (0, 0, 0).

In the embodiment, the framework of the target may be obtained through the 2D image, and the framework of the target may precisely reflect the current posture of the target.

For accurately separating the target from the background, in operation S120 in the embodiment, pixels in the 2D image are traversed so as to determine the distance from each pixel in the 2D image to the framework. In the embodiment, the x^{th} pixel may be any pixel in the 2D image. In the embodiment, for the purpose of differentiation, the distance of the x^{th} pixel relative to the framework is referred to as an x^{th} distance. In the embodiment, the value of x may be smaller than the number of pixels contained in the 2D image.

In the embodiment, whether the x^{th} pixel in the 2D image is a pixel forming the target may be determined based on the x^{th} distance. If the x^{th} pixel is not a pixel forming the target, the x^{th} pixel may be a pixel of the background beyond the target.

Hence, based on the determination of whether the x^{th} pixel is a pixel forming the target, the accurate separation of the target from the background in the 2D image may be implemented.

The limited specific number (such as 14 or 17) of key points are extracted from the 2D image through the deep learning model such as the neutral network to form the framework of the target. Compared with training a deep learning model to determine whether each pixel belongs to the target, the difficulty and processing quantity in data processing are greatly reduced. Thus, the complexity of the deep learning model is greatly reduced, the training of the deep learning model is simplified, and the training speed of the deep learning model is improved. In the embodiments, as the shape of the framework of the target changes with the posture of the target, the target may be accurately separated from the background based on the x^{th} distance as long as the posture of the target is successfully extracted, no matter what posture the target is. Therefore, the problem of insufficient accuracy due to use of a deep learning model having no high recognition rate for some gesture is solved, the training of the deep learning model is simplified, and the accuracy in extracting the target is improved.

In some embodiments, operation S120 may include: a distance between the x^{th} pixel and a line segment where a corresponding framework body in the framework is located is determined. The corresponding framework body is a framework body in the framework nearest to the x^{th} pixel.

As illustrated in FIG. 2 and FIG. 3, the framework is divided into multiple framework bodies by the key points, and a framework body may be considered as a line segment. In the embodiment, in order to calculate the x^{th} distance, the framework body nearest to the x^{th} pixel will be firstly determined based on pixel coordinates of the x^{th} pixel, and in combination with coordinates of the framework of the target in the coordinate system of the camera. Then, the framework body is considered as a line segment to solve the distance from the x^{th} pixel to the line segment. If a perpendicular projection of the x^{th} pixel towards the straight line where the corresponding framework body is located falls onto the framework body, the x^{th} distance may be: a perpendicular distance from the x^{th} pixel to the line segment where the corresponding framework body is located. Alternatively, if the perpendicular projection of the x^{th} pixel towards the straight line where the corresponding framework body is located does not fall onto the framework body, the x^{th} distance may be: a distance from the x^{th} pixel to a nearest endpoint of the line segment where the framework body is located.

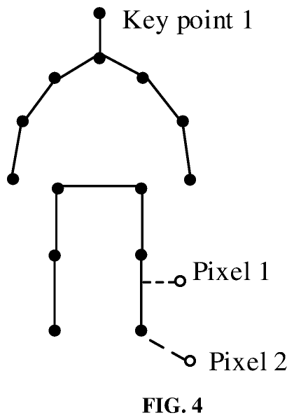

As illustrated in FIG. 4, the framework body nearest to pixel 1 and the framework body nearest to pixel 2 are the same one. However, the distance between pixel 1 and the framework body may be obtained by directly making a perpendicular line towards the line segment where the framework body is located; and the distance between pixel 2 and the framework body is a distance from pixel 2 to the nearest endpoint of the line segment where the framework body is located. In the embodiment, the distance may be denoted by a number of pixels, or may be directly denoted by a spatial distance on the image such as millimeters or centimeters.

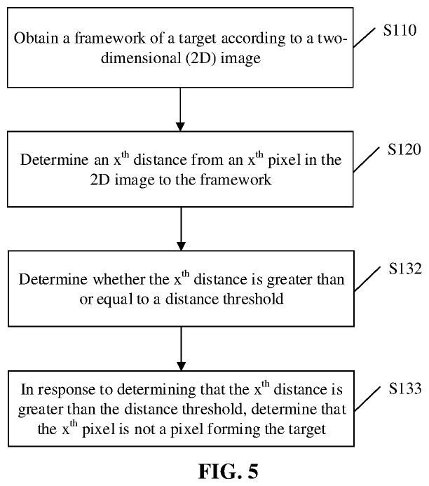

In some embodiments, as illustrated in FIG. 5, operation S130 may include the following operations. In S132: whether the x^{th} distance is greater than or equal to a distance threshold is determined. In S133: in response to determining that the x^{th} distance is greater than the distance threshold, it is determined that the x^{th} pixel is not a pixel forming the target.

In the embodiment, the distance threshold may be a pre-determined value, which may be an empirical value, a statistical value or a simulated value. For example, in some embodiments, a number of pixels spacing a pixel of an arm from a framework body corresponding to the arm may be 10 to 20, or 6 to 15. Of course, these numbers are given as examples only, and the distance threshold is not limited to the specific numbers during practical implementation.

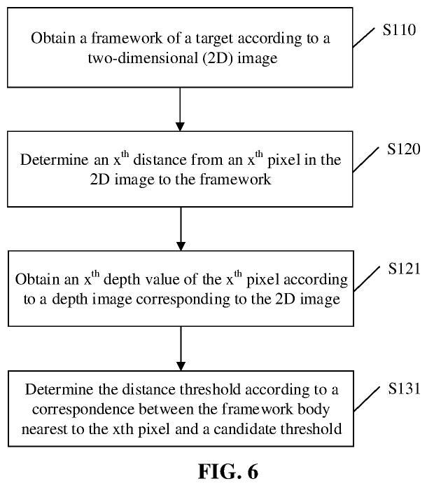

In some embodiments, as illustrated in FIG. 6, the method may further include the following operation. In S131: the distance threshold is determined according to a correspondence between the framework body nearest to the x^{th} pixel and a candidate threshold.

Different framework bodies may correspond to different thresholds. In the embodiment, to explain such correspondences, the electronic device may pre-store or receive from other devices a correspondence between each framework body and a respective candidate threshold. For example, it is determined that the framework body nearest to the x^{th} pixel is a framework body y; and then, a distance threshold may be determined according to a correspondence between the framework body y and a candidate threshold.

In some embodiments, the candidate threshold in correspondence to the framework body y may be directly used as the distance threshold. For example, if there are multiple candidates thresholds in correspondence to the framework body y, one of the multiple alternative thresholds may be selected and output as the distance threshold.

In some other embodiments, the method further includes that: after determining the candidate threshold, the electronic device corrects the candidate threshold by a correction parameter or the like to obtain a final distance threshold.

In some embodiments, operation S131 may include the following operations. A reference threshold is obtained according to the correspondence between the framework body nearest to the x^{th} pixel and the candidate threshold. A relative distance between an acquisition object corresponding to the target and a camera is determined according to a depth image corresponding to the 2D image. An adjustment parameter is obtained according to a size of the framework and the relative distance. The distance threshold is determined according to the reference threshold and the adjustment parameter.

In some embodiments, the distance of the acquisition object away from the camera affects the size of the target in the 2D image. The larger the size of the target is, the greater the distance threshold is; and the smaller the size of the target is, the smaller the distance threshold is. To sum up, the size of the target is positively correlated to the distance threshold. Therefore, in the embodiment, the relative distance between the acquisition object corresponding to the target and the camera may be considered based on the depth image.

The size of the framework reflects the size of the target. Generally, the larger the relative distance is, the smaller the size of the framework is. Therefore, in the embodiment, the adjustment parameter may be obtained based on the size of the framework and the relative distance.

The operation that the adjustment parameter is determined may include that: the size of the target, the relative distance, a focal length and the like may be used to calculate a size ratio of the size of the acquisition object to the size of the target; and a proportional parameter or a weighted parameter may further be obtained based on the size ratio.

The distance threshold is determined based on the reference threshold and the adjustment parameter.

For example, a reference threshold is determined based on the candidate threshold corresponding to the framework body nearest to the x^{th} pixel; and then, an adjustment parameter may be calculated based on the size of the framework (such as the height of the framework and/or the width of the framework). The adjustment parameter may be a proportional parameter and/or a weighted parameter.

If the adjustment parameter is a proportional parameter, the product of the reference threshold multiplied by the proportional parameter may be calculated to obtain the distance threshold.

In some embodiments, the proportional parameter may be: a ratio of the reference size to the actual size of the acquisition object. The actual size of the acquisition object is reversely proportional to the proportional parameter. Explanation is made with the acquisition object being a human person as the example: the taller the human person is, the smaller the proportional parameter is; and the shorter the human person is, the larger the proportional parameter is. In this way, the size of the determined frameworks may be unified, and 3D postures may be acquired using the frameworks of the unified size. The accuracy will be improved, compared with acquiring 3D postures using frameworks of different sizes.

If the adjustment parameter is a weighted parameter, the sum of the reference threshold and the weighted parameter may be calculated to obtain the distance threshold.

In some embodiments, as illustrated in FIG. 6, the method further includes the following operation. In S121, an x^{th} depth value of the x^{th} pixel is obtained according to a depth image corresponding to the 2D image.

Operation S130 may include operation S131 that: whether the x^{th} pixel is a pixel forming the target is determined according to the x^{th} distance and the x^{th} depth value.

In the embodiment, in order to further improve the accuracy in segmenting the target from the background, not only whether a pixel belongs to the target is determined based the distance from the corresponding pixel to the framework of the target, but whether an x^{th} pixel belongs to the target is also determined based on the association relationship between the depth value of the x^{th} pixel and the depth value of an adjacent pixel belonging to the target.

If the target is a human person, the transition on the surface of the human body is relatively gentle, such that depth values in the depth image also transition gently and have no large abrupt change. A large abrupt change may correspond to another object other than the human body.

In some embodiments, operation S130 may include that: it is determined that the x^{th} pixel is a pixel forming the target, in response to that the x^{th} distance meets a first condition, and the x^{th} depth value meets a second condition.

In some embodiments, the event that the x^{th} distance meets the first condition includes: the x^{th} distance is no greater than the distance threshold.

The manner for obtaining the distance threshold herein may refer to the above embodiment, and will not be described again.

In some embodiments, the event that the x^{th} depth value meets the second condition includes: a difference between the x^{th} depth value and a y^{th} depth value being no greater than a depth difference threshold. The y^{th} depth value is a depth value of the y^{th} pixel, the y^{th} pixel is a pixel determined to form the target, and the y^{th} pixel is adjacent to the x^{th} pixel.

In some embodiments, the y^{th} pixel is a pixel adjacent to the x^{th} pixel. Alternatively, the y^{th} pixel is spaced from the x^{th} pixel by a specific number of pixels, for example, 1 or 2 pixels are spaced between the y^{th} pixel and the x^{th} pixel. In some embodiments, whether the pixel spaced between the y^{th} pixel and the x^{th} pixel belongs to the target may be determined according to whether the x^{th} pixel belongs to the target, thereby reducing the calculation quantity, and improving the speed of separating the target from the background.

In the embodiment, in order to ensure that the y^{th} pixel is a pixel of the target, selection of a first y^{th} pixel starts from any pixel on the framework of the target directly. Further preferably, the selection may start from the pixel corresponding to the central point on the framework of the target, or the pixel of the central key point. In the embodiment, with the human skeleton as an example, the central key point may be the above root node but is not limited to the above root node.

In some embodiments, operation S121 may include that: the x^{th} depth value of the x^{th} pixel is obtained during breadth-first search starting from a preset pixel on the framework.

The depth value of each pixel in the depth image may be traversed by the breadth-first search to obtain the depth value of the corresponding pixel. Each pixel in the depth image is traversed by the breadth-first search, such that the missing may be prevented and the target may be accurately segmented from the background.

In some embodiments, N key points are provided on the framework, and the preset pixel is a pixel where a central key point of the N key points is located.

For example, in some embodiments, pixel traversing starts from a reference point based on breadth-first search. If a difference between the depth value corresponding to the first traversed pixel and the depth value corresponding to the reference point is smaller than or equal to a depth difference threshold, it is considered that the first traversed pixel is a pixel forming the target. If the difference between the depth value corresponding to the first traversed pixel and the depth value corresponding to the reference point is greater than the depth difference threshold, it is considered that the first traversed pixel is not a pixel forming the target. As such, the above operation is executed repeatedly to traverse at least a part of, optionally all of, pixels in the image.

When the difference between the depth values corresponding to the m^{th} traversed pixel and the (m−1)^{th} pixel having been determined as forming the target is smaller than or equal to the depth difference threshold, it is considered that the m^{th} pixel is a pixel forming the target. Otherwise, it may be considered that the m^{th} pixel is not a pixel forming the target. The m^{th} pixel may be a pixel adjacent to the (m−1)^{th} pixel.

In some embodiments, each pixel in the 2D image is traversed based on breadth-first search, so as to ensure that no pixel is missed and the accuracy in separating the target from the background.

In some other embodiments, the pixel traversing process based on breadth-first search further includes: whether a traversal stop condition is met is determined according to a depth value difference between the x^{th} pixel and the y^{th} pixel; and if the depth value difference meets the traversal stop condition, the traversal based on breadth-first search is stopped.

The operation that whether the traversal stop condition is met is determined according to the depth value difference between the x^{th} pixel and the y^{th} pixel includes at least one of the following. If the depth value difference between the x^{th} pixel and the y^{th} pixel is greater than a stop threshold, it is determined that the traversal stop condition is met. If a currently counted preset number N of depth value differences between a y^{th} pixel and an x^{th} pixel are greater than the stop threshold, it is determined that the traversal stop condition is met. The number N may be 14 or 17. In some embodiments, the number N may also be 15, such as the key point 0 to the key point 14 illustrated in FIG. 3. Therefore, it is ensured that the first y^{th} pixel for reference in the breadth-first search is located on the target, and the search accuracy is further improved.

In the embodiment, for different acquisition objects, the size of the target that is obtained by the image acquisition module is different. For example, a fatter person occupies more pixels in the 2D image, and a slimmer person occupies less pixels in the 2D image. In the embodiment, in order to improve the accuracy of separating the target from the background, and to reduce the case of misjudging a pixel of the target as that of the background or misjudging a pixel of the background as that of the target, whether a pixel is a pixel forming the target is determined comprehensively in combination with the first condition and the second condition. For example, the distance from a pixel on the body surface of the fatter person to the framework is larger, and the distance from a pixel on the body surface of the slimmer person to the framework is smaller. In this case, based on a normal distance threshold, a pixel beyond the body surface of the slimmer person may be classified as a pixel of the target. For further reducing such misjudgment, the second condition is judged in combination with the depth value. If some slimmer person is photographed in the air, a depth difference between any pixel of the body surface and a pixel of the background wall must be greater than the depth value difference between two adjacent pixels on the body surface. Therefore, by determining whether the second condition is met, at least the error caused by a large distance threshold may be eliminated, and the accuracy of separating the target from the background may be further improved.

According to the technical solutions provided in the embodiments of the application, a framework of a target is firstly extracted according to a 2D image, and then whether a pixel in the 2D image is a pixel of the target is determined based on a distance from the corresponding pixel to the framework, thereby implementing separation of the target from a background. By separating the target from the background in such a manner, a deep learning module may extract a limited specific number of key points from the 2D image to form the framework of the target. By separating the target from the background in such a manner, a deep learning module may extract a limited specific number of key points from the 2D image to form the framework of the target. Thus, compared to the scheme of processing each pixel in the 2D image by a deep learning model, the deep learning model may be simplified, thereby simplifying the training of the deep learning model. In addition, as the target is separated from the background based on a posture of the extracted target, the framework of the target reflects the posture of the target. In the embodiments, as the shape of the framework of the target changes with the posture of the target, the target may be accurately separated from the background based on the x^{th} distance as long as the posture of the target is successfully extracted, no matter what posture the target is. Therefore, the problem of insufficient accuracy due to use of a deep learning model having no high recognition rate for some gesture is solved, the training of the deep learning model is simplified, and the accuracy in extracting the target is improved.

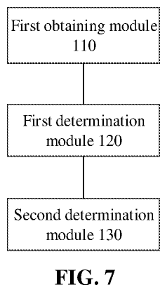

As illustrated in FIG. 7, the embodiment provides an apparatus for processing data, including: a first obtaining module 110, a first determination module 120 and a second determination module 130.

The first obtaining module 110 is configured to obtain a framework of a target according to a two-dimensional (2D) image.

The first determination module 120 is configured to determine an x^{th} distance from an x^{th} pixel in the 2D image to the framework.

The second determination module 130 is configured to determine, according to the x^{th} distance, whether the x^{th} pixel is a pixel forming the target.

In some embodiments, the first obtaining module 110, the first determination module 120 and the second determination module 130 may be program modules that, when executed by a processor, can implement the above functions.

In some other embodiments, each of the first obtaining module 110, the first determination module 120 and the second determination module 130 may also be a combination of a hardware module and a program module, such as a complex programmable array or a field programmable array.

In some embodiments, the first determination module 120 is configured to determine a distance between the x^{th} pixel and a line segment where a corresponding framework body in the framework is located. The corresponding framework body is a framework body in the framework nearest to the x^{th} pixel.

In some embodiments, the second determination module 130 is configured to determine whether the x^{th} distance is greater than or equal to a distance threshold; and in response to determining that the x^{th} distance is greater than the distance threshold, determine that the x^{th} pixel is not a pixel forming the target.

In some embodiments, the apparatus further includes a third determination module.

The third determination module is configured to determine the distance threshold according to a correspondence between the framework body nearest to the x^{th} pixel and a candidate threshold.

In some embodiment, the third determination module is configured to obtain a reference threshold according to the correspondence between the framework body nearest to the x^{th} pixel and the candidate threshold; determine, according to a depth image corresponding to the 2D image, a relative distance between an acquisition object corresponding to the target and a camera; obtain an adjustment parameter according to a size of the framework and the relative distance; and determine the distance threshold according to the reference threshold and the adjustment parameter.

In some embodiments, the apparatus further includes a second obtaining module.

The second obtaining module is configured to obtain an x^{th} depth value of the x^{th} pixel according to a depth image corresponding to the 2D image.

The second determination module 130 is configured to determine, according to the x^{th} distance and the x^{th} depth value, whether the x^{th} pixel is a pixel forming the target.

In some embodiments, the second determination module 130 is configured to determine that the x^{th} pixel is a pixel forming the target in response to that the x^{th} distance meets a first condition, and the x^{th} depth value meets a second condition.

In some embodiments, the event that the x^{th} distance meets the first condition includes: the x^{th} distance being no greater than the distance threshold.

In some embodiments, the event that the x^{th} depth value meets the second condition includes: a difference between the x^{th} depth value and a y^{th} depth value being no greater than a depth difference threshold, wherein the y^{th} depth value is a depth value of a y^{th} pixel, the y^{th} pixel is a pixel determined to form the target, and the y^{th} pixel is adjacent to the x^{th} pixel.

In some embodiments, the second obtaining module is configured to obtain the x^{th} depth value of the x^{th} pixel during breadth-first search starting from a preset pixel on the framework.

In some embodiments, N key points are provided on the framework, and the preset pixel is a pixel where a central key point of the N key points is located.

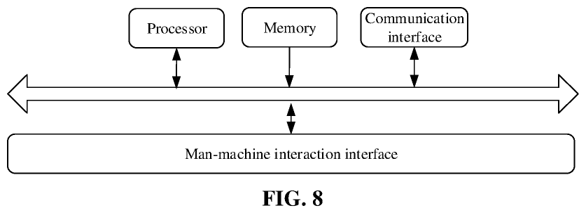

As illustrated in FIG. 8, the embodiment of the disclosure provides an electronic device, including a memory, configured to store information; and a processor, connected to the memory, and configured to execute computer executable instructions stored on the memory to implement the method for processing data provided in one or more technical solutions above, for example, one or more of the methods illustrated in FIG. 1, FIG. 5 and FIG. 6.

The memory may be various types of memories, such as a Random Access Memory (RAM), a Read-Only Memory (ROM) or a flash memory. The memory may be configured to store information, e.g., computer executable instructions. The computer executable instructions may be various program instructions, such as target program instructions and/or source program instructions.

The processor may be various types of processors, such as a central processor, a microprocessor, a digital signal processor, a programmable array, a digital signal processor, an Application Specific Integrated Circuit (ASIC) or an image processor.

The processor may be connected to the memory through a bus. The bus may be an integrated circuit bus, etc.

In some embodiments, the terminal device may further include a communication interface. The communication interface may include a network interface such as a local area network interface or a transceiving antenna. The communication interface is likewise connected to the processor, and can be used for information transceiving.

In some embodiments, the terminal device may further include a man-machine interaction interface. For example, the man-machine interaction interface may include various input/output devices, such as a keyboard, and a touch screen.

An embodiment of the disclosure provides a computer storage medium having computer executable codes stored thereon. The computer executable codes, when executed, can implement the method for processing data provided in the above one or more technical solutions, such as one or more of the methods illustrated in FIG. 1, FIG. 5 and FIG. 6.

The storage medium includes various media capable of storing program codes such as a mobile storage device, a ROM, a RAM, a magnetic disk or an optical disc. The storage medium may be a non-transitory storage medium.

An embodiment of the disclosure provides a computer program product including computer executable instructions which, when executed, can implement the method for processing data provided by the any above embodiment, such as one or more of the methods illustrated in FIG. 1, FIG. 5 and FIG. 6.

In the embodiments provided in the disclosure, it is to be understood that the disclosed device and method may be implemented in other manners. The device embodiment described above is only schematic, and for example, division of units is only division in logical functions. Other division manners may be used during practical implementation. For example, multiple units or components may be combined or integrated into another system, or some features may be neglected or not executed. In addition, coupling or direct coupling or communication connection between displayed or discussed components may be indirect coupling or communication connection implemented through some interfaces, devices or units, and may be electrical, mechanical or in other forms.

The above units described as separate parts may or may not be physically separated, and parts displayed as units may or may not be physical units, namely may be located in the same place or distributed to multiple network units. Some or all of the units may be selected according to a practical requirement to achieve the purpose of the solutions of the embodiments.

In addition, various functional units in the embodiments of the disclosure may all be integrated into a processing module, or each unit may exist as a unit independently, or two or more of the units may be integrated into one unit. The integrated unit may be implemented in a hardware form, or may be implemented in form of hardware plus software functional unit.

Those of ordinary skill in the art should know that all or some of the operations of the abovementioned method embodiment may be implemented by instructing related hardware through a program. The abovementioned program may be stored in a computer-readable storage medium, and the program, when executed, performs operations of the abovementioned method embodiment. The above storage medium includes various media capable of storing program codes, such as a mobile storage, a Read-Only Memory (ROM), a Random Access Memory (RAM), a magnetic disk or an optical disc.

The above is only detailed description of the disclosure and is not intended to limit the scope of protection of the disclosure. Any variations or replacements that readily occur to those skilled in the art within the technical scope of the disclosure shall fall within the scope of protection of the disclosure. Therefore, the scope of protection of the disclosure shall be subjected to the scope of protection of the claims.

1. A method for processing data, comprising:
obtaining a framework of a target according to a two-dimensional (2D) image;
determining an x^{th} distance from an x^{th} pixel in the 2D image to the framework; and
determining, according to the x^{th} distance, whether the x^{th} pixel is a pixel forming the target.

2. The method of claim 1, wherein determining the x^{th} distance from the x^{th} pixel in the 2D image to the framework comprises:
determining a distance between the x^{th} pixel and a line segment where a corresponding framework body in the framework is located, wherein the corresponding framework body is a framework body in the framework nearest to the x^{th} pixel.

3. The method of claim 1, wherein determining, according to the x^{th} distance, whether the x^{th} pixel is a pixel forming the target comprises:
determining whether the x^{th} distance is greater than or equal to a distance threshold; and
in response to determining that the x^{th} distance is greater than the distance threshold, determining that the x^{th} pixel is not a pixel forming the target.

4. The method of claim 3, further comprising:
determining the distance threshold according to a correspondence between a framework body nearest to the x^{th} pixel and a candidate threshold.

5. The method of claim 4, wherein determining the distance threshold according to the correspondence between the framework body nearest to the x^{th} pixel and the candidate threshold comprises:
obtaining a reference threshold according to the correspondence between the framework body nearest to the x^{th} pixel and the candidate threshold;
determining, according to a depth image corresponding to the 2D image, a relative distance between an acquisition object corresponding to the target and a camera;
obtaining an adjustment parameter according to a size of the framework and the relative distance; and
determining the distance threshold according to the reference threshold and the adjustment parameter.

6. The method of claim 1, further comprising:
obtaining an x^{th} depth value of the x^{th} pixel according to a depth image corresponding to the 2D image; and
determining, according to the x^{th} distance, whether the x^{th} pixel is a pixel forming the target comprises:
determining, according to the x^{th} distance and the x^{th} depth value, whether the x^{th} pixel is a pixel forming the target.

7. The method of claim 6, wherein determining, according to the x^{th} distance and the x^{th} depth value, whether the x^{th} pixel is a pixel forming the target comprises:
determining that the x^{th} pixel is a pixel forming the target in response to that the x^{th} distance meets a first condition, and the x^{th} depth value meets a second condition.

8. The method of claim 7, wherein the event that the x^{th} distance meets the first condition comprises:
the x^{th} distance being no greater than a distance threshold.

9. The method of claim 7, wherein the event that the x^{th} depth value meets the second condition comprises:
a difference between the x^{th} depth value and a y^{th} depth value being no greater than a depth difference threshold, wherein the y^{th} depth value is a depth value of a y^{th} pixel, the y^{th} pixel is a pixel determined to form the target, and the y^{th} pixel is adjacent to the x^{th} pixel.

10. The method of claim 6, wherein obtaining the x^{th} depth value of the x^{th} pixel according to the depth image corresponding to the 2D image comprises:
obtaining the x^{th} depth value of the x^{th} pixel during breadth-first search starting from a preset pixel on the framework.

11. The method of claim 10, wherein N key points are provided on the framework, and the preset pixel is a pixel where a central key point of the N key points is located.

12. An apparatus for processing data, comprising:
a processor; and
a memory configured to store instructions which, when being executed by the processor, cause the processor to carry out the following:
obtaining a framework of a target according to a two-dimensional (2D) image;
determining an x^{th} distance from an x^{th} pixel in the 2D image to the framework; and
determining, according to the x^{th} distance, whether the x^{th} pixel is a pixel forming the target.

13. The apparatus of claim 12, wherein the instructions, when being executed by the processor, cause the processor to carry out the following:
determining a distance between the x^{th} pixel and a line segment where a corresponding framework body in the framework is located, wherein the corresponding framework body is a framework body in the framework nearest to the x^{th} pixel.

14. The apparatus of claim 12, wherein the instructions, when being executed by the processor, cause the processor to carry out the following:
determining whether the x^{th} distance is greater than or equal to a distance threshold; and
in response to determining that the x^{th} distance is greater than the distance threshold, determining that the x^{th} pixel is not a pixel forming the target.

15. The apparatus of claim 14, the instructions, when being executed by the processor, cause the processor to carry out the following:
determining the distance threshold according to a correspondence between a framework body nearest to the x^{th} pixel and a candidate threshold.

16. The apparatus of claim 15, wherein the instructions, when being executed by the processor, cause the processor to carry out the following
obtaining a reference threshold according to the correspondence between the framework body nearest to the x^{th} pixel and the candidate threshold;
determining, according to a depth image corresponding to the 2D image, a relative distance between an acquisition object corresponding to the target and a camera;
obtaining an adjustment parameter according to a size of the framework and the relative distance; and
determining the distance threshold according to the reference threshold and the adjustment parameter.

17. The apparatus of claim 12, wherein the instructions, when being executed by the processor, further cause the processor to carry out the following:
obtaining an x^{th} depth value of the x^{th} pixel according to a depth image corresponding to the 2D image,
wherein in determining, according to the x^{th} distance, whether the x^{th} pixel is a pixel forming the target, the instructions, when being executed by the processor, cause the processor to carry out the following: determining, according to the x^{th} distance and the x^{th} depth value, whether the x^{th} pixel is a pixel forming the target.

18. The apparatus of claim 17, wherein the instructions, when being executed by the processor, cause the processor to carry out the following:
determining that the x^{th} pixel is a pixel forming the target in response to that the x^{th} distance meets a first condition, and the x^{th} depth value meets a second condition,
wherein the event that the x^{th} distance meets the first condition comprises: the x^{th} distance being no greater than a distance threshold; or
wherein the event that the x^{th} depth value meets the second condition comprises: a difference between the x^{th} depth value and a y^{th} depth value being no greater than a depth difference threshold, wherein the y^{th} depth value is a depth value of a y^{th} pixel, the y^{th} pixel is a pixel determined to form the target, and the y^{th} pixel is adjacent to the x^{th} pixel.

19. The apparatus of claim 17, wherein the instructions, when being executed by the processor, cause the processor to carry out the following:
obtaining the x^{th} depth value of the x^{th} pixel during breadth-first search starting from a preset pixel on the framework, wherein N key points are provided on the framework, and the preset pixel is a pixel where a central key point of the N key points is located.

20. A non-transitory computer-readable storage medium having stored thereon computer programs that, when being executed by a computer, cause the computer to carry out the following:
obtaining a framework of a target according to a two-dimensional (2D) image;
determining an x^{th} distance from an x^{th} pixel in the 2D image to the framework; and
determining, according to the x^{th} distance, whether the x^{th} pixel is a pixel forming the target.
